(19) United States
(12) Patent Application Publication
(10) Pub. No.: US 2025/0180304 A1
(43) Pub. Date: Jun. 5, 2025

(54) HEAT STORAGE REACTION SYSTEM, SLIDING JIG, AND METHOD OF REPLACING MATERIAL MODULES IN HEAT STORAGE REACTION SYSTEM USING THE SAME

(71) Applicant: Samsung Electronics Co., Ltd., Suwon-si (KR)

(72) Inventors: SUNGMIN JANG, Suwon-si (KR); Hyunmin Jeong, Suwon-si (KR); Seounghwan Hyeon, Suwon-si (KR); SEJIN PARK, Suwon-si (KR)

(21) Appl. No.: 18/930,173

(22) Filed: Oct. 29, 2024

(30) Foreign Application Priority Data
Dec. 1, 2023 (KR) 10-2023-0172668

(51) Int. Cl. F28D 20/02; F28D 20/00

(52) U.S. Cl. CPC F28D 20/023; F28D 20/003; F28D 2020/0008

(57) ABSTRACT

A heat storage reaction system according to an embodiment includes: a chamber that includes a combustion chamber; a plurality of beds that are disposed in a lower portion of the chamber, in which a plurality of trays having a material module disposed therein are fixed to form layers; a connection passage that connects the lower portion of the chamber and upper portions of each bed; and a valve that controls opening and closing of the connection passage, in which each of the beds may include one or more opening and closing parts with one side surface opened.

### CROSS-REFERENCE TO RELATED APPLICATION

This application claims priority under 35 U.S.C. § 119 and the benefit thereof to Korean Patent Application No. 10-2023-0172668, filed in the Korean Intellectual Property Office on Dec. 1, 2023, the entire contents of which are incorporated herein by reference.

### BACKGROUND OF THE INVENTION

### (a) Field of the Invention

The present disclosure relates to a heat storage reaction system for replacing material modules during operation, a sliding jig, and a method of replacing material modules in a heat storage reaction system using the same.

### (b) Description of the Related Art

Volatile organic compounds (VOCs) are substances that are easily evaporated in the atmosphere due to their high vapor pressure, and generate photochemical oxidizing substances such as ozone and polyacrylonitrile (PAN) through photochemical reactions under the action of sunlight when they coexist with nitrogen oxides in the atmosphere to cause photochemical smog, and the sources of occurrence of the volatile organic compounds are diverse. In addition, volatile organic compounds (VOCs) are not only emitted into the atmosphere by organic solvents and fuel consumed in vehicles using liquid fuel, but are also variously emitted from solvents, chemical and pharmaceutical factories, plastic manufacturing processes, etc.

Hydrocarbon-based volatile organic compounds (VOCs) and harmful gases may be generated in most production processes based on chemical processes. Since components of the VOCs, etc., not only have a significant impact on the human body, but also have a significant impact on the atmospheric environment, when the components of the VOCs are present in the atmosphere, the components of the VOCs may cause secondary environmental pollution, so technology for treating the components of the VOCs is very important.

As a heat storage combustion facility for removing organic exhaust gases, a regenerative thermal oxidizer (RTO) and a regenerative catalytic oxidizer (RCO) are used.

### SUMMARY OF THE INVENTION

The present disclosure relates to increasing facility efficiency when replacing a material module in a conventional heat storage combustion facility, and providing a heat storage reaction system in which opening and closing of connection passages between a chamber and a plurality of beds may be individually controlled, and material modules inside the beds may be replaced regardless of an operating state of the heat storage type reaction system, a sliding jig, and a method of replacing material modules in a heat storage reaction system using the same.

In addition, the present disclosure relates to a heat storage reaction system in which at least one side surface of a bed can be opened and closed, and thus, a replacement operation can be performed from the outside without the need for workers to enter the heat storage reaction system, and material modules spaced apart from each other on a tray composed of a plurality of layers that can be replaced independently through a sliding jig, regardless of the order in which the material modules are disposed, a sliding jig, and a method of replacing material modules in a heat storage reaction system using the same.

According to an embodiment, a heat storage reaction system includes: a chamber that includes a combustion chamber; a plurality of beds that are disposed in a lower portion of the chamber, each bed of the plurality of beds including a plurality of trays, each tray of the plurality of trays having a material module disposed therein and fixed to form layers; a plurality of connection passages each connection passage connecting the lower portion of the chamber and an upper portion of each bed; and a plurality of valves, each valve configured to control opening and closing of a corresponding one of the connection passages, wherein each of the beds includes one or more opening and closing parts on one side surface.

According to another embodiment, a sliding jig that is disposed in a pair to face each other in parallel on both sides of a material module disposed on a tray in a bed of a heat storage reaction system, and draws out the material module from the heat storage reaction system, includes: a rail part that includes a rail extending along a longitudinal direction of the material module; a main body that is provided with a guide on an inner side surface through which the rail moves; and a lifting part that has an upper surface coupled to the main body and a bottom fixed to the tray.

According to still another embodiment, a method of replacing material modules in a heat storage reaction system including a plurality of beds includes: blocking, by a valve disposed at a connection passage between one bed of the plurality of beds and a chamber, the connection passage connecting the one bed and the chamber; opening, by an opening and closing part disposed on a side surface of the one bed, one side surface of the one bed; inserting a sliding jig into the one bed through the opened one side surface; drawing out, by the sliding jig, a material module to be replaced; and inserting, by the sliding jig, a new material module into the one bed to seat the new material module on a seating part of a tray in the one bed.

According to embodiments, it is possible to normally operate a heat storage reaction system by blocking only one bed where an operation of replacing material modules is performed from a chamber and opening and replacing one surface of the blocked bed.

In addition, the plurality of material modules may be independently disposed in the bed, and independently replaced regardless of positions of each material module through a front surface of the bed opened through an opening and closing part.

### BRIEF DESCRIPTION OF THE DRAWINGS

FIG. 1 is a diagram illustrating a conventional heat storage reaction facility.

FIGS. 2A and 2B are diagrams illustrating a heat storage reaction system according to an example embodiment.

FIGS. 3A and 3B are diagrams illustrating a method of replacing material modules in a heat storage reaction system according to an example embodiment.

FIGS. 4A and 4B are diagrams illustrating the heat storage reaction system according to the example embodiment.

FIG. 5 is a diagram illustrating a heat storage reaction system according to another example embodiment.

FIGS. 6A and 6B are diagrams illustrating a bed of the heat storage reaction system according to the example embodiment.

FIGS. 7A and 7B are diagrams illustrating the bed of the heat storage reaction system according to the example embodiment.

FIGS. 8A and 8B are diagrams illustrating material modules disposed in the heat storage reaction system according to the example embodiment.

FIGS. 9A and 9B are diagrams illustrating the heat storage reaction system according to the example embodiment.

FIG. 10 is a diagram illustrating the heat storage reaction system according to the example embodiment.

FIGS. 11A and 11B are diagrams illustrating a process of replacing a material module in a conventional heat storage reaction system, and FIG. 11C is a diagram illustrating a process of replacing a material module in a heat storage reaction system according to an example embodiment.

FIG. 12 is a diagram illustrating a sliding jig according to an example embodiment.

FIG. 13 is a diagram illustrating the sliding jig according to the example embodiment.

FIGS. 14A and 14B are diagrams illustrating an operation of the sliding jig according to the example embodiment.

FIG. 15 is a diagram illustrating the operation of the sliding jig according to the example embodiment.

FIG. 16 is a diagram illustrating an operation process of the heat storage reaction system illustrated in FIGS. 4A and 4B.

FIGS. 17A and 17B are diagrams illustrating the process of replacing the material modules in the heat storage reaction system.

FIG. 18 is a diagram illustrating the operation process of the heat storage reaction system illustrated in FIGS. 17A and 17B.

FIGS. 19A and 19B are diagrams illustrating a method of replacing material modules in a heat storage reaction system according to an example embodiment.

FIGS. 20A and 20B are diagrams illustrating the method of replacing material modules in a heat storage reaction system according to the example embodiment.

FIGS. 21A to 21C are diagrams illustrating the method of replacing material modules in a heat storage reaction system according to the example embodiment.

FIGS. 22A and 22B are diagrams illustrating the method of replacing material modules in a heat storage reaction system according to the example embodiment.

FIG. 23 is a flowchart of the operation process of the heat storage reaction system illustrated in FIGS. 17A and 17B.

### DETAILED DESCRIPTION OF THE EMBODIMENTS

Hereinafter, embodiments of the present disclosure will be described in detail with reference to the accompanying drawings so that those skilled in the art to which the present disclosure pertains may easily practice the present disclosure. The present disclosure may be modified in various different forms, and is not limited to embodiments provided in the present specification. Like reference characters refer to like elements throughout.

Portions unrelated to the description will be omitted in order to obviously describe the present disclosure in the drawings, and similar components will be denoted by the same reference numerals throughout the present specification.

In addition, the size and thickness of each component illustrated in the drawings are arbitrarily indicated for convenience of description, and the present disclosure is not necessarily limited to those illustrated. In the drawings, the thickness of layers, films, panels, regions, etc. are exaggerated for clarity. In addition, in the accompanying drawings, thicknesses of some of layers and regions have been exaggerated for convenience of explanation.

Throughout the present specification, when any one part is referred to as being “connected to” another part, it means that any one part and another part are “directly connected to” each other or are “indirectly connected to” each other with the other part interposed therebetween. In addition, unless explicitly described to the contrary, the word “comprise”, and variations such as “comprises” or “comprising”, will be understood to imply the inclusion of stated elements but not the exclusion of any other elements.

In addition, it will be understood that when an element such as a layer, a film, a region, or a substrate is referred to as being “above” or “on” another element, it may be directly on another element or may have an intervening element present therebetween. In contrast, when an element is referred to as being “directly on” another element, there are no intervening elements present. In addition, when an element is referred to as being “on” a reference element, it can be positioned on or beneath the reference element, and is not necessarily positioned on the reference element in an opposite direction to gravity.

Further, throughout the specification, the word “plan view” refers to a view when a target is viewed from the top, and the word “cross-sectional view” refers to a view when a cross section of a target taken along a vertical direction is viewed from the side.

Currently, in a heat storage combustion facility for removing organic exhaust gases and greenhouse gases, a regenerative thermal oxydizer (RTO) and a regenerative catalytic oxidizer (RCO) have been used.

First, a regenerative thermal oxydizer (RTO) combusts inflowing waste gas using stored heat. This may directly store a heat amount generated when volatile organic compounds (VOCs) gases is combusted using a ceramic heat storage material for heat exchange, and allow the volatile organic compounds (VOCs) gases to be combusted appropriately by raising the temperature of the volatile organic compounds (VOCs) gases using this stored heat.

The regenerative catalytic oxidizer (RTO) may remove organic solvents or organic odors and at the same time recover and supply heat using heat storage materials for heat exchange without discharging a significant amount of combustion heat generated to the outside, thereby preventing air pollution and very efficiently using waste heat emitted to the outside.

Next, like the regenerative catalytic oxidizer, the regenerative catalytic oxidizer (RCO) stores the heat amount generated when the volatile organic compounds (VOCs) gases are combusted using a heat exchange device such as a ceramic heat storage material, and preheats the inflowing volatile organic compounds (VOCs) gases with this stored heat and oxidizes the inflowing volatile organic compounds (VOCs) gases at low temperature while passing through a catalyst layer. Accordingly, it is more economical as the temperature is lowered to 200 to 400° C. compared to a thermal combustion temperature of 800° C.

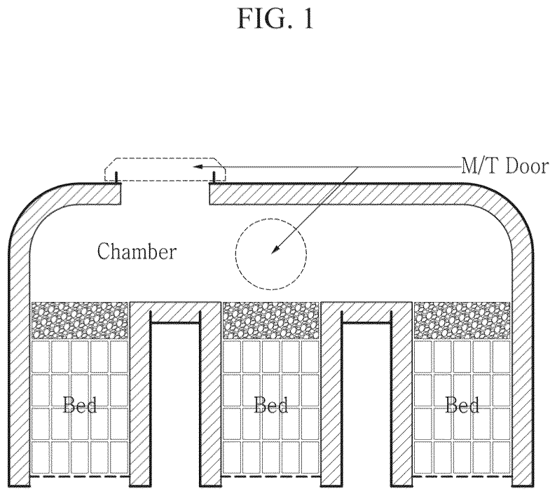

FIG. 1 is a diagram illustrating a conventional heat storage reaction facility.

FIG. 1 is a heat storage reaction facility that oxidizes harmful substances in exhaust gas and recycles combustion heat using the heat storage material. The combustion takes place in a chamber at a top, and the combustion heat is recycled using catalysts and heat storage materials loaded in three beds at a bottom. A gas flow is changed to repeat the heat storage and preheating.

The exhaust gas flows in through a lower portion of each bed connected to a lower portion of the chamber, and the exhaust gas flowing in through a burner in the chamber is heated up to the reaction temperature. Thereafter, the heated exhaust gas goes through an oxidation reaction while passing through a catalyst layer loaded on a top of the bed, absorbs the remaining reaction heat in a heat storage material layer loaded on a bottom, and is then discharged to the outside.

After a certain period of time, the gas flow changes in the opposite direction. In this case, the exhaust gas flows into the heated heat storage material layer, goes through a preheating process, and is then oxidized in the catalyst layer and discharged.

As illustrated in FIG. 1, in the case of the heat storage combustion facility having a bed type oxidizer structure, the entire heat storage material, catalyst, etc., should be replaced to maintain exhaust gas treatment efficiency after a certain usage cycle. However, since workers should enter the facility during the replacement operation, there is a problem of lowering facility efficiency, such as having to stop facility operation.

In the conventional heat storage reaction facility, the bed and chamber are continuous spaces that are not separated, and in order to replace materials such as the catalysts and heat storage materials in the bed, the operation of the equipment has to stop for the time required to ensure an appropriate environment for workers to work and to replace the materials.

Specifically, in order to replace the materials in the conventional heat storage reaction facility, the facility stops, the inside of the facility is cooled, and then a worker enters the chamber through a maintenance door (M/T door) illustrated in FIG. 1. This is because the materials loaded in the bed may not be approached without going through the M/T door in the chamber. Here, it takes at least 10 hours to secure an appropriate environment for workers to work by stopping the operation of the facility and cooling the facility's internal temperature to enter the facility.

After entering through the M/T door of the chamber, it was possible to move to the bed to be replaced and approach the materials loaded in the bed. However, workers who approach the upper portion of the bed have no choice but to sequentially remove the materials stacked on the upper portion of the bed and the materials stacked on the lower portion, and then load new materials from the lower portion again.

In addition, even when a simple inspection is needed for some of the materials stacked in the bed, it is necessary to stop the facility operation, cool the inside, and then remove all the materials. In other words, in order to check materials stacked in a middle of the bed, the materials have no choice but to be replaced by a sequential method of removing all materials stacked on an upper portion of a targeted material, inspecting the materials, and then stacking the materials on the upper portion again.

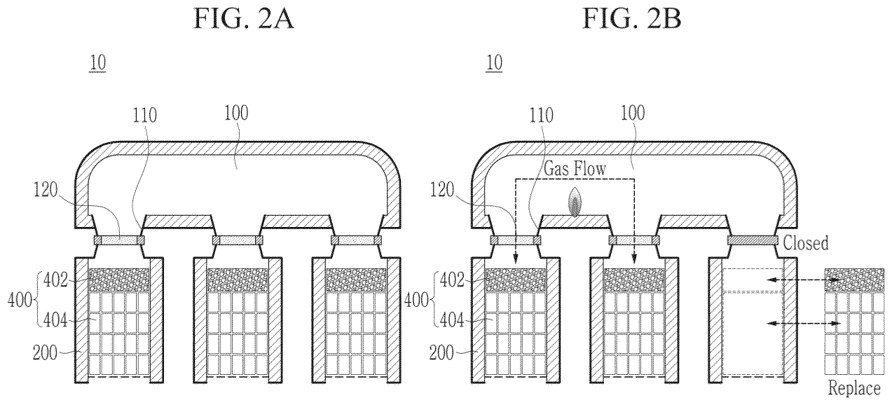

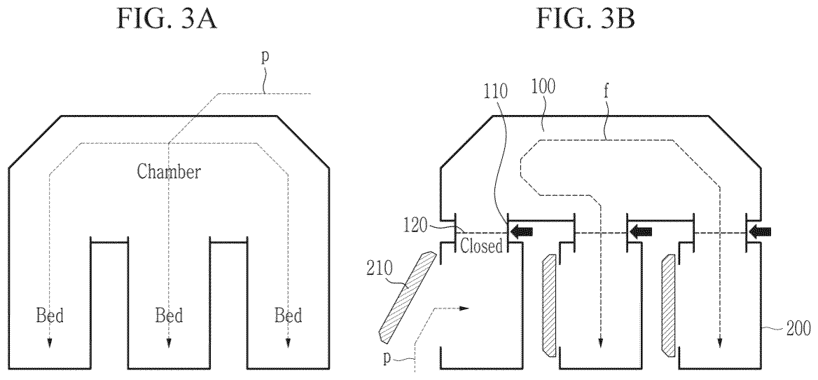

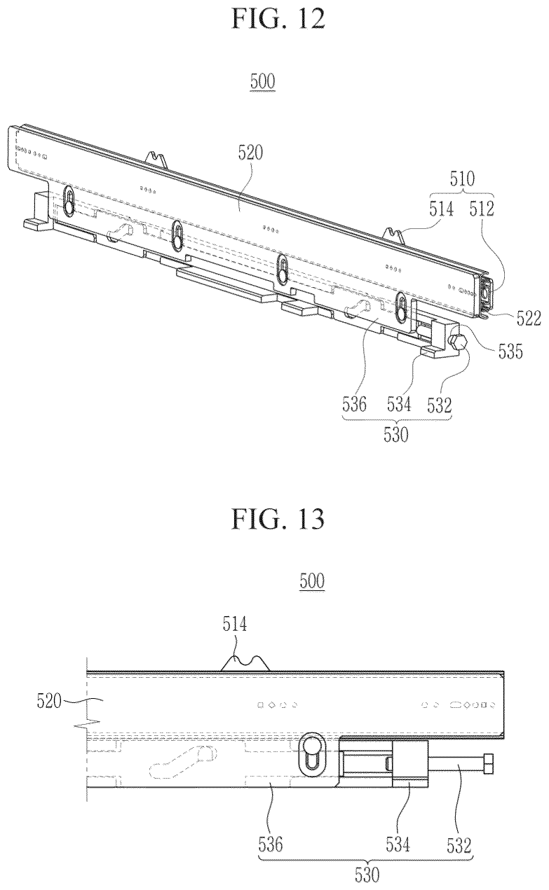

In the process of replacing materials in the conventional heat storage reaction facility, there is the problem as described above. Accordingly, through a heat storage reaction system (e.g., heat storage reaction system 10 of FIGS. 2A-2B and 3A-3B) and a sliding jig (e.g., sliding jig 500 of FIG. 12) according to the present disclosure and a method of replacing material modules in a heat storage reaction system using the same, it is intended to increase facility efficiency in the operation of replacing the material module in the heat storage reaction system.

Hereinafter, with reference to the drawings, the heat storage reaction system 10, the sliding jig 500, and the method of replacing material modules in the heat storage reaction system using the same according to the embodiment of the present disclosure will be described in more detail.

FIGS. 2A and 2B are diagrams illustrating the heat storage reaction system according to an example embodiment. FIGS. 3A and 3B are diagrams illustrating the method of replacing material modules in a heat storage reaction system according to the example embodiment.

FIG. 2A is illustrated to describe a structure of the heat storage reaction system 10. As illustrated in FIG. 2A, the heat storage reaction system 10 according to the present disclosure includes a chamber 100 disposed at a top and a plurality of beds 200 disposed at a bottom that are connected by a connection passage 110, and a valve 120 that can be opened and closed is disposed in the connection passage 110.

A material module 400 is disposed inside the bed 200. Specifically, a catalyst module 402 may be disposed at a top, and a heat storage material module 404 may be disposed at a bottom of the catalyst module.

Hereinafter, in the heat storage reaction system 10 and the method of replacing material modules in a heat storage reaction system, the regenerative catalytic oxidizer (RCO), which is a structure in which both the catalyst module 402 and the heat storage material module 404 are disposed inside the bed 200, will be described as an example.

However, the heat storage reaction system 10 and the method of replacing material modules in the heat storage reaction system according to the present disclosure are not limited only to the regenerative catalytic oxidizer (RCO), and may also be applied to the regenerative catalytic oxidizer (RTO) which is configured to have a single configuration of the heat storage material module 404.

FIG. 2B illustrates the heat storage reaction system 10 in operation, and illustrates a process of replacing the material module 400 while the heat storage reaction system 10 is in operation.

The operating heat storage reaction system 10 illustrated in FIG. 2B is currently going through combustion within the chamber 100, and in the beds 200 disposed at the left and the middle of the plurality of beds 200 disposed at the bottom of the chamber 100, gas is flowing along an arrow. At the same time, in the bed 200 disposed on the right, the material modules 400 stacked inside the bed 200 are being replaced.

In this case, it may be confirmed that each valve 120 disposed on the connection passage 110 connecting the beds 200 disposed on the left and middle and the chamber 100 is in an opened state, and the valve 120 disposed on the connection passage 110 connecting the bed 200 and the chamber 100 disposed on the right are in a closed state.

FIG. 3A illustrates that, in order to replace the materials inside the bed in the conventional heat storage reaction facility illustrated in FIG. 1, each bed is approached through the M/T door formed at the top of the chamber (p).

FIG. 3B illustrates that, in order to replace the material module 400 inside the bed 200 in the heat storage reaction system 10 according to the present disclosure, the material module 400 inside the bed 200 is replaced by directly opening an opening and closing part 210 formed on one side surface of the bed 200 while the valve 120 on the top of the bed 200 including the material module 400 to be replaced is closed. In FIG. 3B, it may be confirmed that the material module 400 is replaced in the bed 200 with the valve 120 closed, and at the same time, the reaction is in progress as gas flows between the bed 200 and the chamber 100 with the valve 120 open (f).

That is, in the case of the heat storage reaction system 10 according to the present disclosure, only the bed 200 on which the operation of replacing the material module 400 is performed is blocked from the chamber, and as one surface of the blocked bed 200 is opened and replaced, the heat storage reaction system 10 may be operated normally through the plurality of beds 200 other than the bed 200 including the material module 400 to be replaced.

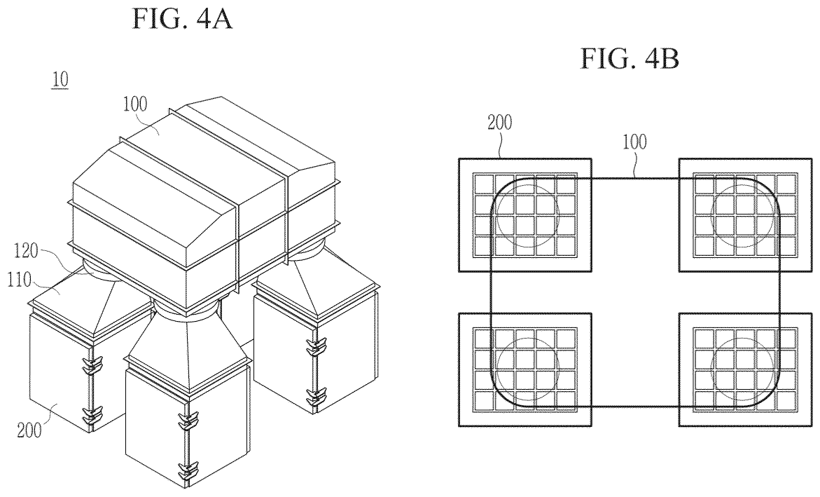

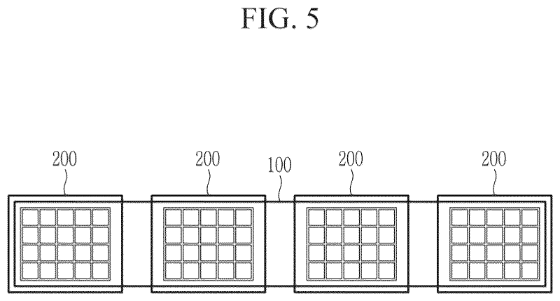

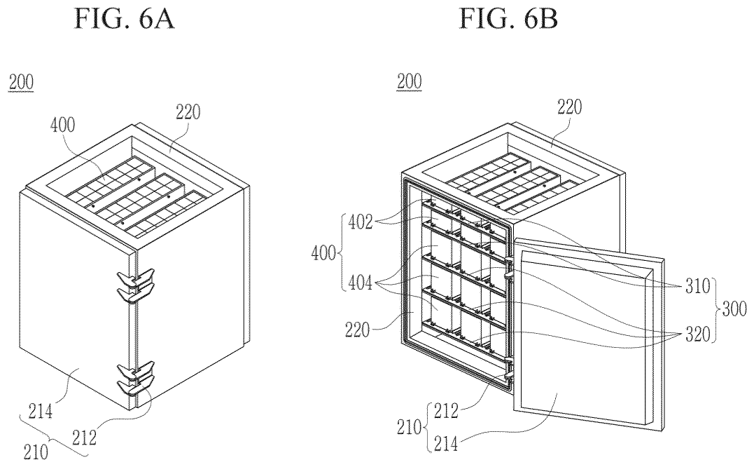

FIGS. 4A and 4B are diagrams illustrating the heat storage reaction system according to the example embodiment. FIG. 5 is a diagram illustrating a heat storage reaction system according to another example embodiment. FIGS. 6A and 6B are diagrams illustrating the bed of the heat storage reaction system according to the example embodiment.

FIG. 4A is a perspective view illustrating an appearance of the heat storage reaction system 10 according to the present disclosure. FIG. 4B is a top view illustrating the appearance of FIG. 4A, and illustrates the disposition relationship of the chamber 100, the bed 200, and the connection passage 110.

As an embodiment, the heat storage reaction system 10 is illustrated in which four beds 200 are connected to each corner of one chamber 100. For example, each bed 200 is connected to a respective corner of the same chamber 100.

First, as illustrated in FIGS. 4A and 6A and 6B, the heat storage reaction system 10 according to the present disclosure may include the chamber 100 including the combustion chamber, the plurality of beds 200 that are disposed at the lower portion of the chamber 100 and include a plurality of trays 300 having the material modules 400 disposed therein and arranged in layers, and the connection passages 110 that connect the lower portion of the chamber 100 and the upper portions of each bed 200. According to the embodiment, the connection passage 110 connecting the chamber 100 and the bed 200 may be a duct.

In addition, the heat storage reaction system 10 includes the valve 120 that controls the opening and closing of the connection passage 110, and each bed 200 may include one or more opening and closing parts 210 that open and close one side surface.

As illustrated in FIGS. 4A and 4B, the chamber 100 disposed at the top is connected to the plurality of beds 200 disposed at the bottom by the connection passages 110, and the process of moving gas, which has gone through the heat storage and preheating process in bed 200, to the chamber 100 at the top through the connection passage 110, and returning the gas from the chamber 100 to the bed 200 may be repeated.

Each of the four beds 200 and the chamber 100 are divided by the valve 120 that may block each space, and the valve 120 is opened and closed as necessary to restrict the inflow of the high-temperature combustion gas from the chamber 100 into the bed 200. The bed 200, from which the gas inflow is blocked by closing the valve 120, is maintained in an independent state regardless of the operating state of the heat storage reaction system 10.

Depending on the structure of the bed 200, which will be described below, each material module 400 may be independently replaced through a front surface of the bed 200 without a worker entering the chamber 100. Accordingly, the heat storage reaction system 10 according to the present disclosure may shorten a cooling time in the system for the replacement operation of the material module 400 compared to the related art, and reduce the time required for replacement and maintenance of the material module 400 in that the material module 400 can be replaced even when the internal temperature is high.

FIG. 5 illustrates the structure of the heat storage reaction system 10 according to another embodiment, and as in FIG. 4A, it is a structure in which four beds 200 are connected to one chamber 100, but corresponds to an embodiment in which the disposition positions of the beds 200 are different. For example, the four beds 200 may be provided in a single row to be attached to the chamber 100 in a lengthwise direction.

In order to perform the replacement and maintenance operation on one bed 200 while maintaining the operation of the heat storage reaction system 10, in the heat storage reaction system 10 according to the present disclosure, which has a structure capable of blocking the connection with the chamber 100, the number of beds 200 should be at least four.

This is because, in the structure in which the chamber 100 and the bed 200 are connected, the number of operating beds 200 should be at least three to perform a function of preventing untreated gas from leaking to the outside.

Accordingly, the heat storage reaction system 10 according to the present disclosure has a structure having at least four beds 200, and may be disposed in a structure (circular type) as illustrated in FIG. 4B and may be disposed in a straight line structure (serial type) as illustrated in FIG. 5.

FIGS. 6A and 6B are diagrams illustrating the bed 200 disposed at the bottom of the chamber 100. FIG. 6A illustrates that the opening and closing part 210 disposed on the side surface of the bed 200 is closed, and FIG. 6B illustrates that the opening and closing part 210 is opened. The opening and closing part 210 disposed on the side surface of the bed 200 may have a size and shape such that the entire side surface is closed and/or opened, and the opening and closing part 210 may be disposed on at least one of the four side surfaces.

The opening and closing part 210 disposed on one side surface of the bed 200 is coupled to the other side surface of the adjacent bed 200 by a connector 212, and may include a door 214.

The connector 212 may be a toggle clamp type, which may minimize a decrease in sealing force between the bed 200 and the opening and closing part 210.

An inner side surface of the door 214 and an inner circumference of the side surface of the bed 200, which is in contact with an outer circumference of the door 214, may be surrounded by a refractory 220, and the bed 200 may have a shape in which an upper edge in contact with the connection passage 110 connected to the top is surrounded by the refractory 220.

The material module 400 is loaded in the bed 200. As illustrated in FIG. 6B, the catalyst module 402 in which a catalyst is accommodated may be disposed at the top, and the heat storage material module 404 in which a heat storage material is accommodated may be disposed at a bottom of the catalyst module 402.

Each material module 400 is disposed at a top of the layered tray 300, and the tray 300 may include a first tray 310 on which the catalyst module 402, in which the catalyst is accommodated, is disposed and a second tray 320 on which the heat storage material module 404, in which the heat storage material is accommodated, is disposed. In example embodiments, the first tray 310 may be a plurality of first trays 310, and a catalyst module 402 may be disposed on each of the first trays 310. In addition, in example embodiments, the second tray 320 may be a plurality of second trays 320, and a heat storage material module 404 may be disposed on each of the second trays 320.

The plurality of trays 300 are disposed in parallel at regular intervals from each other, and both ends of each tray may be fixed to an inner wall of the bed 200.

As the plurality of trays 300 are spaced apart at regular intervals, an upper surface of the material module 400 seated on each tray 300 does not contact a lower surface of the tray 300, and the material module 400 and the tray 300 may be spaced apart from each other with a certain amount of clearance.

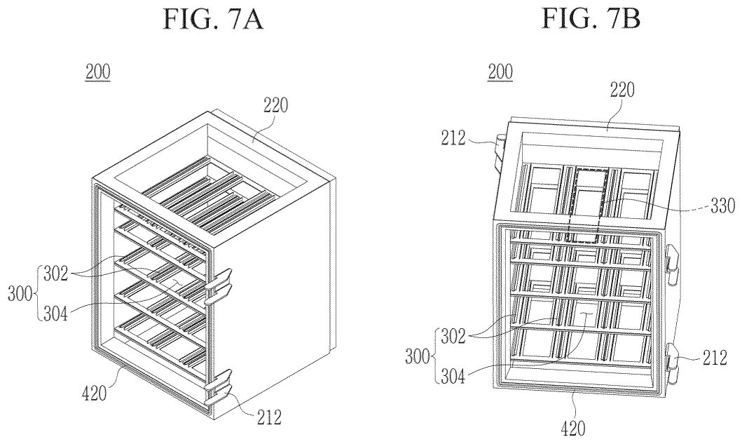

FIGS. 7A and 7B are diagrams illustrating the bed of the heat storage reaction system according to the embodiment.

FIGS. 7A and 7B are diagrams illustrating an internal structure of the bed 200, and illustrate that, among the opening and closing parts 210, the door 214 is not illustrated, and the structure of the bed 200 in which the opening and closing parts 210 are disposed on front and rear surfaces of the bed 200, respectively.

In FIGS. 7A and 7B, a gasket 420 may be disposed around a side circumference of the bed 200 that is in contact with a circumference of the door 214, and the gasket 420 disposed at an edge serves to prevent the treated gas and heat from leaking from inside the bed 200.

As illustrated in FIGS. 7A and 7B, each of the trays 300 forming a plurality of layers inside the bed 200 may include a circumference portion 302 having a shape along a lower circumference where the material module 400 is disposed, and a central portion 304 having a hole provided inside the circumference portion 302. For example, the tray 300 may be composed of the circumference portion 302, which is the frame itself forming the tray 300, and the central portion 304 with holes between the frames, and the material module 400 may be disposed on an upper surface of the circumference portion 302 of the tray 300.

In the drawing, the entire central portion 304 is illustrated to form a hole, but according to the embodiment, the central portion 304 may have a mesh structure.

In addition, in FIG. 7B, a seating part 330 is indicated as a portion where the material module 400 is seated in the portion where a lower surface of the material module 400 and the upper surface of the circumference portion 302 of the tray 300 are in contact with each other. Each material module 400 may be seated on the seating part 330 in the circumference portion 302 of the tray 300.

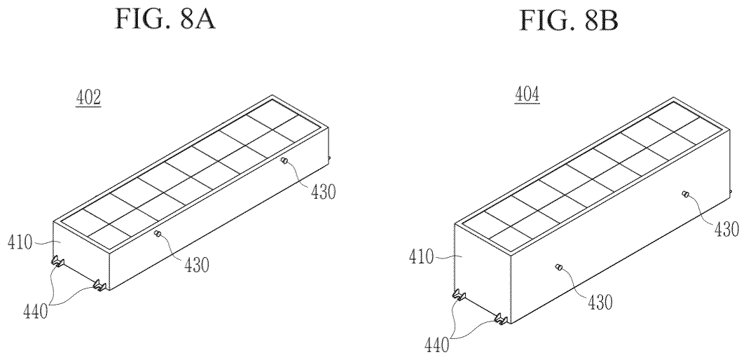

FIGS. 8A and 8B is a diagram illustrating material modules disposed in the heat storage reaction system according to the embodiment.

FIG. 8A illustrates the catalyst module 402 among the material modules 400. FIG. 8B illustrates the heat storage material module 404 among the material modules 400.

Each material module 400 includes a housing 410 that has catalyst and heat storage materials accommodated therein. For example, the housing 410 may have catalysts and heat storage materials in the form of honeycomb, pellets, or beads loaded therein.

The housing 410 accommodating the materials may be seated on the seating part 330 of the tray 300.

In addition, pin-shaped first coupling parts 430 are provided on both outer surfaces of the material module 400, and a third coupling part 440 coupled to the tray 300 may be provided while seated on the tray 300 at a front lower portion relative to a longitudinal direction of the material module 400.

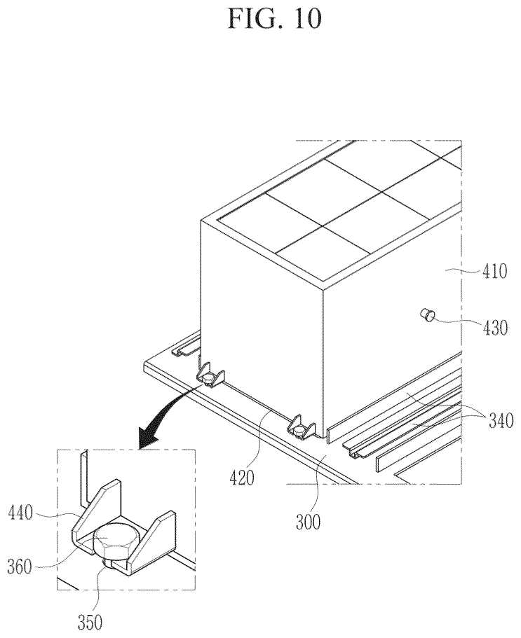

As will be described in FIG. 10 below, a fourth coupling part 350 of the tray 300 may be coupled to the material module 400 and a bolt 360 through the third coupling part 440, and the material module 400 may be fixed to the tray 300 through the coupling.

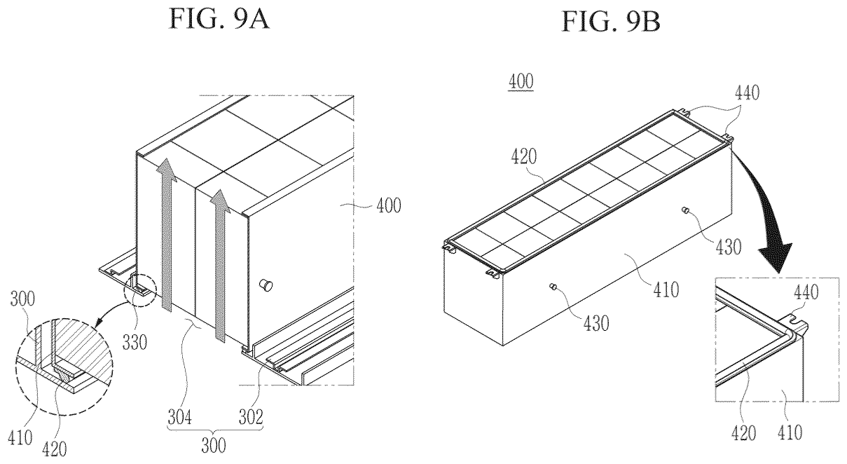

FIGS. 9A and 9B are diagrams illustrating the heat storage reaction system according to the example embodiment.

FIG. 9A illustrates that the material module 400 is seated on an upper surface of the tray 300, and is a diagram illustrating a middle cross section of the seated material module 400.

The housing 410 of the material module 400 may be seated on the seating part 330 in the circumference portion 302 of the tray 300, and the tray 300 may be disposed along a lower circumference of the housing 410 of the material module 400. For example, the gasket 420 may be disposed between the seating part 330 and a lower surface of the housing 410 of the material module 400 as illustrated in FIG. 9A.

The circumference portion 302 of the tray 300 serves to support the material module 400. The central portion 304 provided with the holes serves as a gas flow passage, and the gas flowing through the central portion 304 comes out or in through an upper surface of the housing 410 through the housing 410 with the lower surface opened. The tray 300 and the material module 400 seated on the tray 300 form a plurality of layers, but gas may flow from the lower portion of the bed 200 to the upper portion of the bed 200 through the central portion 304 of the tray 300 and the opened lower surface of the housing 410 of the material module 400.

FIG. 9B illustrates the gasket 420 disposed at a lower portion of the material module 400, and illustrates the material module 400 turned over so that the lower portion of the material module 400 is visible. As illustrated, the gasket 420 may be disposed along a circumference of the lower surface of the housing 410. The leakage of the untreated gas may be blocked by compressing the gasket 420 disposed between the material module 400 and the tray 300.

In FIGS. 6 and 7, the refractory 220 disposed on an upper circumference of the bed 200 and the inner side surface of the door 214, and the gasket 420 disposed on the side surface of the bed 200 in contact with the opening and closing part 210 serve to prevent the treated gas and heat from leaking from inside the bed 200.

FIG. 10 is a diagram illustrating the heat storage reaction system according to the example embodiment.

FIG. 10 illustrates a front surface of the material module 400 mounted on the tray 300, and the material module 400 may include the third coupling part 440 coupled to the tray 300, and the tray 300 may include the fourth coupling part 350 at a position corresponding to the third coupling part 440. The third coupling part 440 and the fourth coupling part 350 may be coupled to each other through the bolt 360 while the material module 400 is seated on the tray 300.

The material module 400 may be fixed to the seating part 330 on the upper surface of the tray 300 by its own load and fastening force generated by the coupling of the bolt 360 between the third coupling part 440 and the fourth coupling part 350, and block the leakage of the untreated gas by compressing the gasket 420 disposed on a contact surface of the upper surface of the tray 300 and the lower surface of the housing 410.

In addition, fixing parts 340 having a protruding shape may be provided on both sides of the seating part 330 on which the material module 400 is seated. The fixing part 340 serves to fix the sliding jig 500, which will be described in FIG. 12 below, to the tray 300, and the first coupling parts 430 provided on both sides of the outer surface of the material module 400 serves to couple the sliding jig 500 and the material module 400.

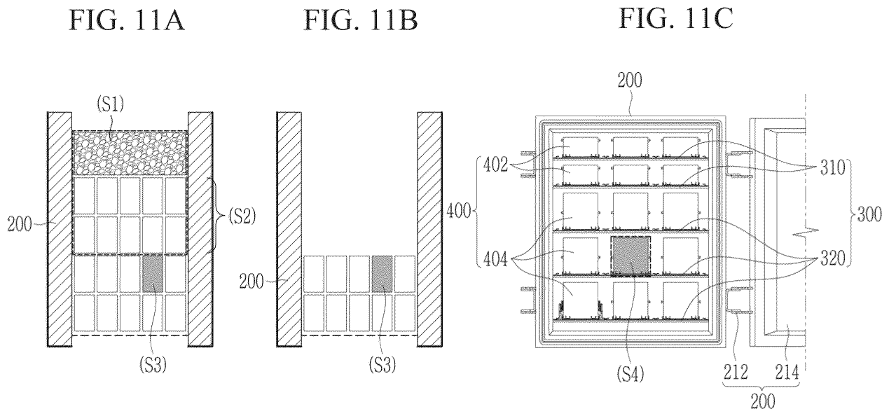

FIGS. 11A to 11C are diagrams illustrating a process of replacing a material module in a heat storage reaction system.

FIGS. 11A and 11B illustrate the process of replacing the material module 400 disposed in the bed of the conventional heat storage reaction facility as illustrated in FIG. 1. FIG. 11C illustrates a process of replacing the material module 400 within the bed 200 of the heat storage reaction system 10 according to the present disclosure.

First, in the case of the conventional heat storage reaction facility, the replacement of the material modules 400 stacked inside the bed is performed in a last-in, first-out manner. Therefore, in order to remove the earlier inserted material module 400, it is necessary to first remove the subsequently inserted material module 400.

As illustrated in FIGS. 11A and 11B, in order to replace the material module (s3) 400 loaded in the middle, the material module (s1) 400 disposed at the top inside the bed is removed, all of the material modules (s2) 400 placed below the material module (s1) 400 are removed, and then the material module (s3) 400 may be replaced.

In the case of the heat storage reaction system 10 according to the present disclosure, as illustrated in FIG. 11C, the plurality of material modules 400 are seated on one plane on each tray 300, and the plurality of material modules 400 mounted on the same tray 300 are arranged at regular intervals.

In addition, each tray 300 may also be disposed to be spaced apart from the upper surface of the material module 400 disposed at the lower portion by a certain distance. That is, since the trays 300 forming different layers are disposed to be spaced apart by a certain distance, the material module 400 is not limited to the tray 300 disposed at the upper portion.

Accordingly, the replacement operation of the material modules 400 disposed to be spaced apart from each other may be performed by opening the opening and closing part 210 disposed in a front surface of the bed 200, and independently drawing out each material module 400 in the front direction in which the opening and closing part 210 is opened.

For example, the material modules 400 may have a structure in which they may be moved independently by being spaced apart from each other, so the material module 400 may be replaced by drawing out the material module 400 disposed in the middle without removing the material modules 400 disposed at the top of the bed 200.

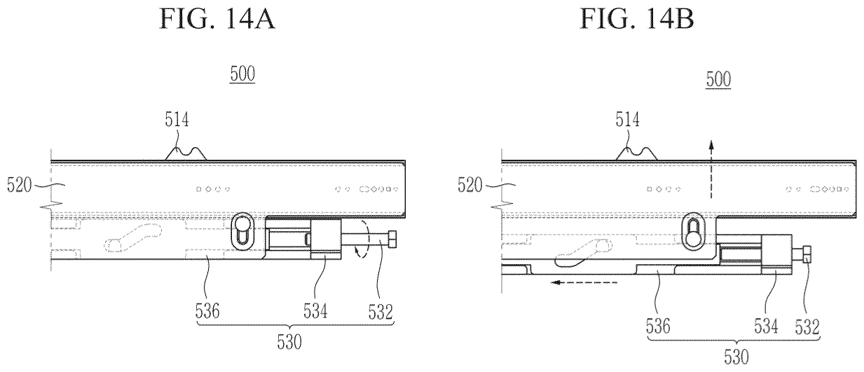

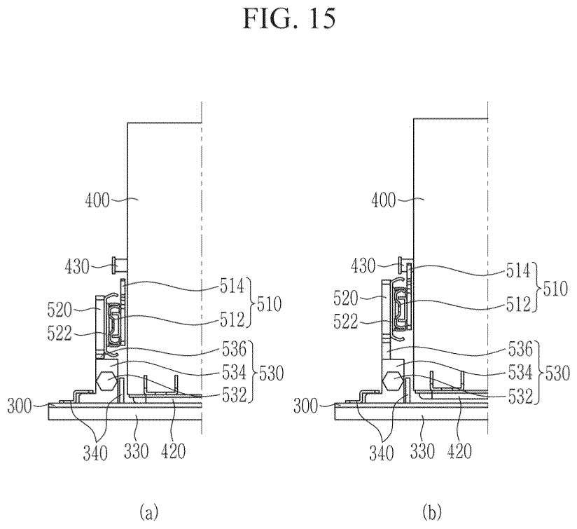

FIGS. 12 and 13 are diagrams illustrating a sliding jig according to an example embodiment. FIGS. 14A and 14B are diagrams illustrating an operation of the sliding jig according to the example embodiment.

FIGS. 12 to 14B illustrate a sliding jig 500, and the sliding jig 500 according to the present disclosure serves to draw out the material module 400 from the heat storage reaction system 10 described in FIGS. 2 to 11.

Specifically, the sliding jig 500 according to the present disclosure may be disposed in a pair to face each other in parallel on both sides of the material module 400 disposed on the tray 300 in the bed 200 of the heat storage reaction system 10 and draw out the material module 400 from the heat storage reaction system 10.

For example, the sliding jig 500 may be disposed on both sides of the material module 400 so that the material module 400 illustrated in FIGS. 8A and 8B is positioned between the pair of sliding jigs 500.

The heat storage reaction system 10 includes the plurality of beds 200 in which the material module 400 including the first coupling part 430 is disposed and to which the plurality of trays 300 on which the material modules 400 are seated are fixed, and the sliding jig 500 may be coupled to the first coupling parts 430 provided on both outer surfaces of the material module 400, and draw out the material module 400 out of the bed 200 in the coupled state.

Hereinafter, the structure of the sliding jig 500 will be described in detail.

As illustrated in FIGS. 12 and 13, the sliding jig 500 according to the present disclosure may include a rail 512 that extends along the longitudinal direction of the material module 400, and a rail part 510 that is provided with a tooth-shaped second coupling part 514 that can be coupled to the pin-shaped first coupling parts 430 provided on both sides of the material module 400 at a top of the rail 512. The rail 512 of the rail part 510 may be a telescopic sliding rail.

In addition, a guide 522 along which the rail 512 moves is provided on an inner side surface, and may include a main body 520 to which a lifting part 530 is coupled at the bottom. The lifting part 530 may have an upper surface coupled to the main body 520 and a bottom fixed to the fixing part 340 of the tray 300.

The lifting part 530 moves the main body 520 upward so that the second coupling part 514 is coupled to the first coupling part 430, and thus, serves to separate the material module 400 from the upper surface of the tray 300.

The lifting part 530 may include a lifting bolt 532 that has one end penetrating through a clamp 534 according to rotation about a longitudinal axis, a hole 535 that is disposed along a longitudinal direction of the lifting bolt 532 and has the lifting bolt 532 penetrating therethrough, the clamp 534 whose bottom is fixed to the fixing part 340, and a cam plate 536 that has one end connected to the clamp 534, is disposed along the longitudinal direction of the lifting part 530, and has an upper surface in contact with the main body 520. In example embodiments, the lifting bolt 532 may be configured to rotate about a longitudinal axis.

As illustrated in FIG. 14A, when the lifting bolt 532 having one end penetrating through the hole 535 of the clamp 534 rotates about its axis, as illustrated in FIG. 14B, by moving the cam plate 536 horizontally and at the same time moving the cam plate 536 upward, the main body 520 may be moved upward.

FIG. 15 is a diagram illustrating the operation of the sliding jig according to the example embodiment.

The tray 300 may include the fixing part 340 for fixing the sliding jig 500 to the tray 300 on both sides of the seating part 330 on which the material module 400 is seated.

FIG. 15 (a) is a diagram illustrating the state in which the sliding jig 500 is fixed to the fixing part 340 of the tray 300, and the state in which a protrusion at the bottom of the clamp 534 of the sliding jig 500 is fitted into a groove of the fixing part 340 of the tray 300 and is fixed to the upper surface of the tray 300.

FIG. 15 (a) illustrates a state before the first coupling part 430 provided in the material module 400 and the second coupling part 514 of the sliding jig 500 are coupled.

FIG. 15 (b) illustrates that in the state fixed to the tray 300 as in FIG. 15 (a), as the cam plate 536 moves upward by the rotation of the lifting bolt 532, the main body 520 moves upward, and thus, the second coupling part 514 provided on a top of the rail part 510 is coupled to the first coupling part 430 provided on the outer surface of the material module 400.

In FIGS. 15 (a) and 15 (b), there is a difference in that the cam plate 536 disposed between the clamp 534 and the main body 520 moves upward, and as the second coupling part 514 is coupled to the first coupling part 430 and the material module 400 itself is lifted upward, the bottom of the material module 400 is spaced apart from the tray 300.

As a result, as illustrated in FIG. 15 (b), the gasket 420 disposed at the bottom of the housing 410 of the material module 400 is spaced apart from the seating part 330 of the tray 300.

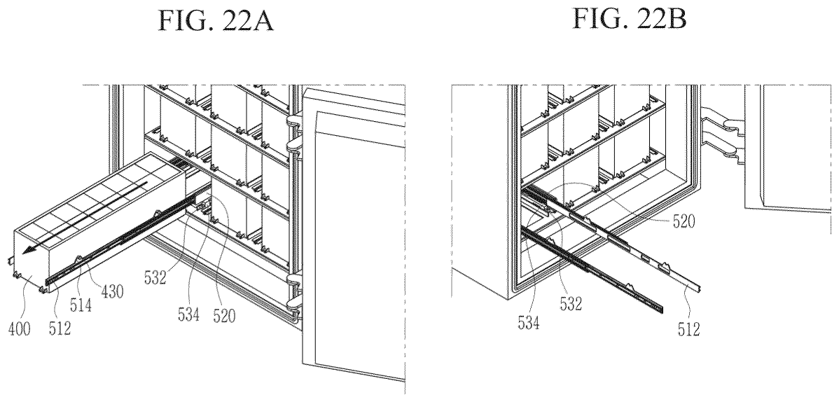

The sliding jig 500 according to the present disclosure is fixed to the tray 300 and then coupled to the material module 400 to separate the material module 400 from the tray 300. As illustrated in FIGS. 22A and 22B below, in a state in which the first coupling part 430 of the material module 400 and the second coupling part 514 provided at the top of the rail part 510 are coupled, the rail 512 of the rail part 510 may move to the outside of the bed 200 along the guide 522 provided inside the main body 520 of the sliding jig 500.

The rail part 510 has a structure that may slide along the guide 522 provided inside the main body 520, and separates the first coupling part 430 of the material module 400 from the second coupling part 514 of the rail part 510 that moves to the outside of the bed 200 to completely remove the material module 400 from the sliding jig 500.

Separating the material module 400 from the upper surface of the tray 300 by rotating the lifting bolt 532 of the sliding jig 500 is to remove the friction force generated between the lower surface of the material module 400 and the upper surface of the tray 300, and to prevent damage to the gasket 420 disposed on the bottom of the material module 400.

When the material module 400 is dragged out to the outside of the bed 200 without lifting the material module 400 upward, with the material module 400 in contact with the seating part 330 of the tray 300, the friction force is generated at the contact surface between the material module 400 and the tray 300, which inevitably causes damage to the gasket 420.

As described above, the sliding jig 500 according to the present disclosure may allow the material module 400 to be easily drawn out from the bed 200 by sliding to the outside of the bed 200 while fixed to the tray 300 in the bed 200, and be disposed on both outer surfaces of the material module 400 seated on the seating part 330 of the tray 300 and coupled to the material module 400.

The sliding jig 500 can be stored separately, and when the material module 400 disposed in the bed 200 of the heat storage reaction system 10 needs to be replaced, the sliding jig 500 may be mounted inside the bed 200 for the replacement operation to perform the operation of drawing out the material module 400. The sliding jig 500 is disposed within the bed 200 only when replacement operation is in progress and is stored outside the bed 200 at normal times to prevent damage due to high temperature and chemicals within the heat storage reaction system 10.

In particular, the sliding jig 500 is fixed to the tray 300 by pushing the sliding jig 500 into the fixing part 340 of the tray 300 so that it is parallel to the tray 300, so it is possible to prevent the sliding jig 500 from being pushed or moved laterally on the tray 300 during the process of drawing out the material module 400.

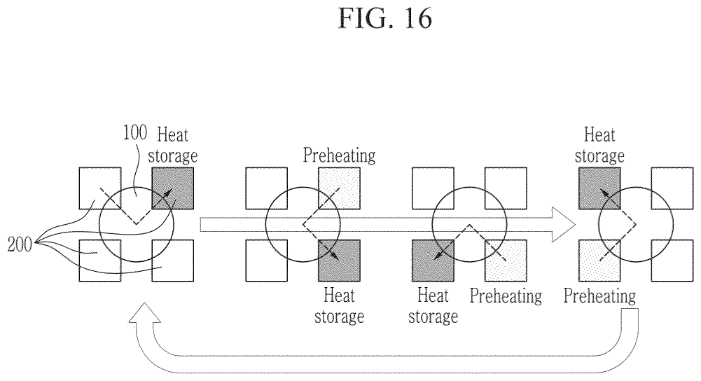

FIG. 16 is a diagram illustrating an operation process of the heat storage reaction system illustrated in FIG. 4.

FIG. 16 is a diagram illustrating the heat storage and preheating processes that occur in each bed 200 while the heat storage reaction system 10 according to the present disclosure illustrated in FIGS. 4A and 4B is operating.

All four beds 200 and the chamber 100 are connected without being blocked, and the heat storage and preheating may be performed in all four beds 200. Gas moves from the bed 200 disposed at the top left to the bed 200 disposed at the top right. In this case, the heat storage process is performed in the bed 200 disposed at the top right. Next, as the gas moves from the bed 200 disposed at the top right to the bed 200 disposed at the bottom right, the preheating process is performed in the bed 200 disposed at the top right, and the heat storage process is performed in the bed 200 disposed at the bottom right.

Likewise, as the gas moves from the bed disposed at the bottom right to the bed 200 disposed at the bottom left, and from the bed 200 disposed at the bottom left to the bed 200 disposed at the top left, the preheating and heat storage process is repeatedly performed in each bed 200.

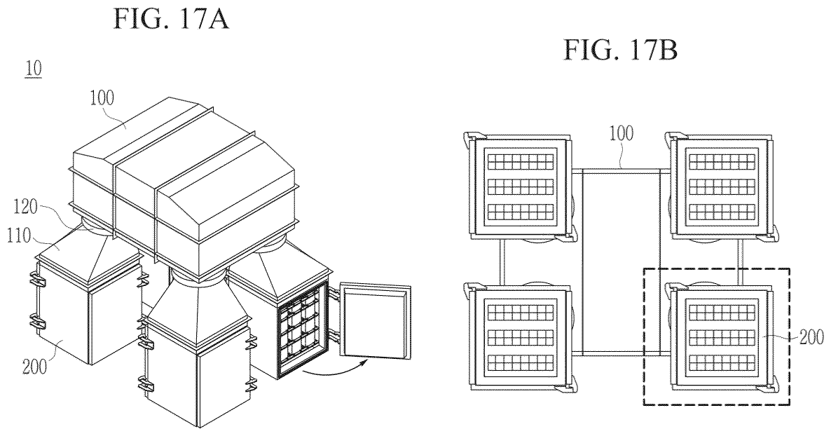

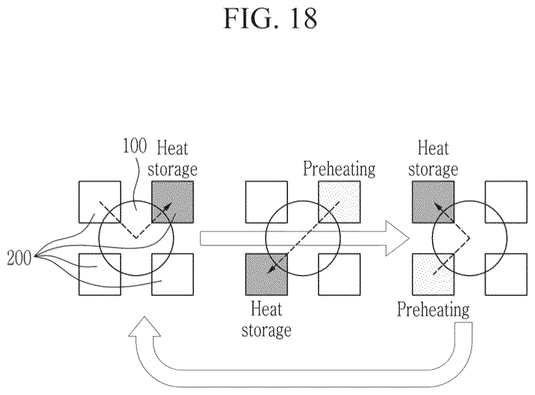

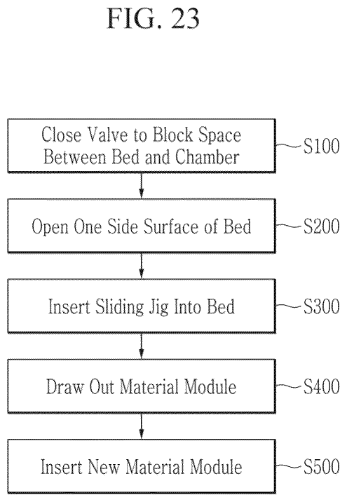

FIGS. 17A and 17B are diagrams illustrating the process of replacing the material modules in the heat storage reaction system. FIG. 18 is a diagram illustrating the operation process of the heat storage reaction system illustrated in FIGS. 17A and 17B. FIG. 23 is a flowchart of the operation process of the heat storage reaction system illustrated in FIGS. 17A and 17B.

FIG. 17A illustrates that, during the operation of the heat storage reaction system 10 according to the present disclosure, the opening and closing part 210 on the side surface of the bed 200 is in an opened state to perform the replacement of the material module 400 in one bed 200. FIG. 17B is a diagram illustrating an appearance viewed from the bottom of FIG. 17A to check the position of the bed 200 where the material module 400 is being replaced.

FIG. 18 illustrates the heat storage and preheating process performed in the bed 200 while the heat storage reaction system 10 is operating, assuming that the material module 400 is replaced in the bed 200 at the same position (bottom right) as in FIG. 17B.

Unlike in FIG. 16, in FIG. 18, the preheating and heat storage processes is not performed in the bed 200 disposed at the bottom right while the bed 200 disposed at the bottom right is blocked (e.g., blocked by valve 120). In the heat storage reaction system according to the present disclosure, when the material replacement or maintenance is performed in one bed 200, the gas inflow into the corresponding bed 200 is blocked, and the gas moves from the remaining bed 200.

As illustrated in FIG. 18, the gas moves through the chamber 100 from the bed 200 disposed at the upper right to the bed 200 disposed at the lower left. In this case, there is a difference in that the preheating process is performed in the bed 200 disposed at the top right, and the heat storage process is performed in the bed 200 disposed at the bottom left.

The preheating and heat storage process has been sufficiently performed with three beds 200 and the heat storage reaction system 10 can operate normally, so there is no problem in that the material module 400 is being replaced in the bed 200 disposed at the bottom right.

Referring to FIGS. 17A and 17B, together with FIG. 23, the method of replacing a material module 400 in a heat storage reaction system 10 according to the present disclosure relates to a method of replacing material modules 400, each independently disposed in the bed 200, using the sliding jig 500 in the heat storage reaction system 10 including the plurality of beds 200 described above.

The method of replacing a material module 400 in a heat storage reaction system 10 may include, first, a step (S100) in which the valve 120 disposed on the upper portion of the bed 200 and disposed in the connection passage 110 connecting the bed 200 and the chamber 100 is closed to block the space between the bed 200 and the chamber 100, a step (S200) of opening one side surface of the bed 200 by the opening and closing part 210 disposed on the side surface of the bed 200, a step (S300) of inserting the sliding jig 500 into the bed 200 through the opened side surface, a step (S400) in which the sliding jig 500 draws out the material module 400 that needs to be replaced, and a step (S500) in which the sliding jig 500 inserts the new material module 400 into the bed 200, and the new material module 400 is seated in the position where the drown out material module 400 was seated.

Here, the heat storage reaction system 10 is the heat storage reaction system 10 described with reference to FIGS. 2 to 11 above, and the sliding jig 500 corresponds to the sliding jig described with reference to FIGS. 12 to 15.

Hereinafter, the step of inserting the sliding jig 500 into the bed 200 and the step of drawing out the material module 400 will be described in detail.

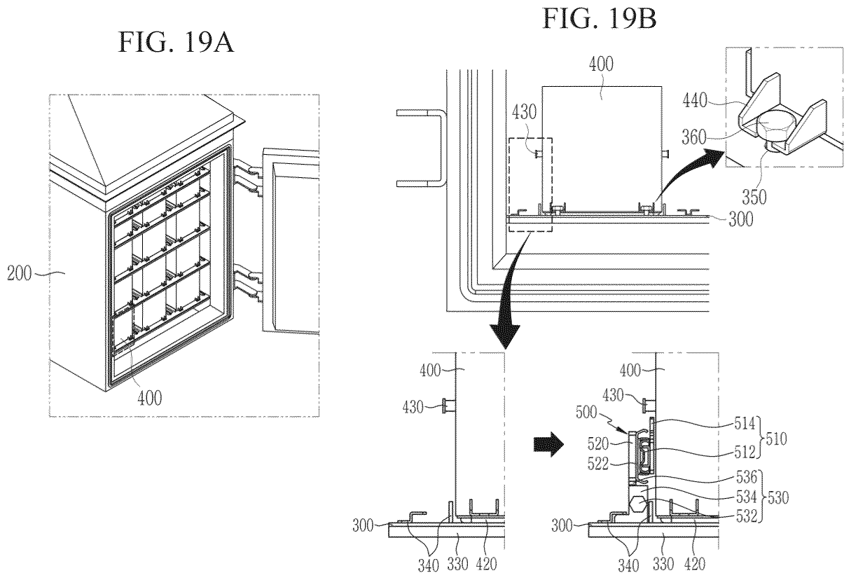

FIGS. 19A and 19B are diagrams illustrating the method of replacing material modules in a heat storage reaction system according to the embodiment.

FIG. 19A illustrates that the opening and closing part 210 disposed on one side surface of the bed 200 of the heat storage reaction system 10 is in an opened state, and illustrates the plurality of material modules 400 each independently disposed in the plurality of trays 300 inside the bed 200. As illustrated, the material module 400 disposed at the bottom left is specified as the material module 400 to be replaced, and the method of replacing a material module 400 will be described.

FIG. 19B is an enlarged view illustrating the material module 400 disposed at the bottom left of FIG. 19A and the tray 300 on which the material module 400 is seated.

As illustrated, the fixing part 340 having the groove may be provided on the circumference of the seating part 330 of the tray 300 to fit a protrusion of the clamp 534 of the sliding jig 500, and the sliding jig 500 may be fixed to the tray 300 by inserting the sliding jig 500 into the fixing part 340.

Accordingly, the step (S300) of inserting the sliding jig 500 into the bed 200 may include disposing the protrusion at the bottom of the clamp 534 of the sliding jig 500 to fit into the groove of the fixing part 340 of the tray 300 and then inserting the sliding jig 500 into the bed 200 parallel to the tray 300.

Immediately after the sliding jig 500 is coupled and fixed to the fixing part 340 of the tray 300, as illustrated in the drawing below FIG. 19B, the second coupling part 514 of the sliding jig 500 is in a state where it is not in contact with the first coupling part 430 provided on the side surface of the material module 400.

According to the embodiment, as illustrated in FIG. 19B, before fixing the sliding jig 500 to the tray 300, the method may include releasing the coupling of the bolt 360 of the third coupling part 440 disposed on the front surface of the housing 410 of the material module 400 and the fourth coupling part 350 disposed on the upper surface of the tray 300 at the position corresponding to the third coupling part 440.

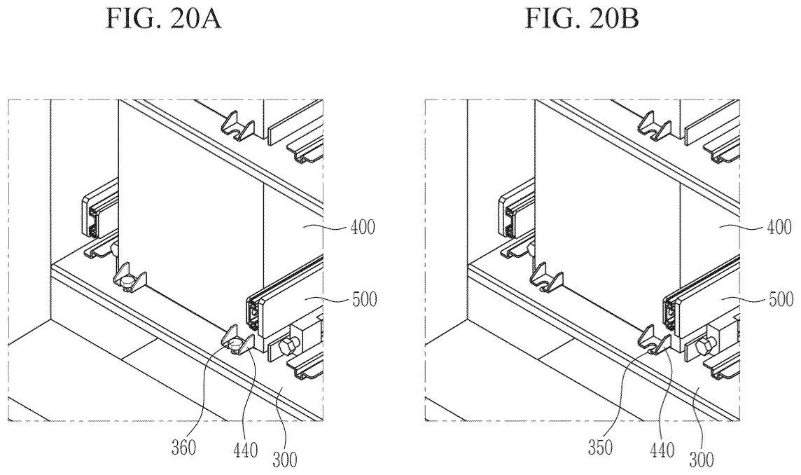

FIGS. 20A and 20B are diagrams illustrating the method of replacing material modules in a heat storage reaction system according to the embodiment.

FIG. 20A is a diagram illustrating the state in which the sliding jig 500 is coupled to the fixing part 340 of the tray 300. As illustrated, the third coupling part 440 of the material module 400 and the fourth coupling part 350 of the tray 300 is coupled by the bolt 360.

FIG. 20B illustrates the state in which the coupling of the bolt 360 of the third coupling part 440 and the fourth coupling part 350 in FIG. 20A is released, and according to the embodiment, after the sliding jig 500 is fixed and coupled to the tray 300, the coupling of the bolt 360 of the third coupling part 440 and the fourth coupling part 350 may be released.

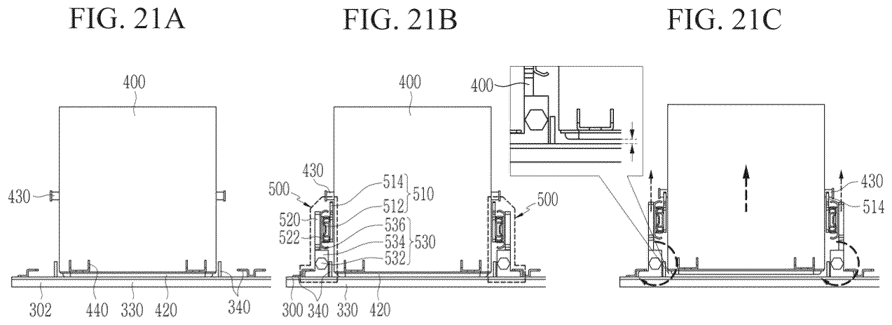

FIGS. 21A to 21C and 22A and 22B are diagrams illustrating a method of replacing material modules in a heat storage reaction system according to an embodiment.

FIGS. 21A to 21C sequentially illustrate the process of coupling the sliding jig 500 to the material module 400 seated on the tray 300.

First, FIG. 21A illustrates a state in which the coupling of the bolt 360 between the third coupling part 440 and the fourth coupling part 350 is released after the material module 400 is seated on the tray 300. In FIG. 21B, the sliding jig 500 is fixed to the tray 300 by fitting the protrusion of the clamp 534 of the sliding jig 500 into the fixing part 340 of the tray 300.

FIG. 21C illustrates the process of separating the material module 400 from the seating part 330 of the tray 300 by lifting the material module 400 upward using the sliding jig 500 fixed to the tray 300.

As illustrated in FIG. 21C, separating the material module 400 from the tray 300 may include lifting the main body 520 of the sliding jig 500 as the lifting bolt 532 of the sliding jig 500 rotates in one direction, and coupling the second coupling part 514 provided at the top of the rail part 510 of the sliding jig 500 to the first coupling parts 430 provided on both outer surfaces of the material module 400.

As the second coupling part 514 and the first coupling part 430 are coupled, the second coupling part 514 lifts the material module 400 upward, and accordingly, the compression force caused by the gasket 420 disposed at the bottom of the material module 400 may be released.

In addition, the friction force between the lower surface of the material module 400 and the upper surface of the tray 300 is eliminated, ensuring the freedom of horizontal movement during the process of drawing out the material module 400 to the outside of the bed 200 together with the sliding jig 500.

As illustrated in FIG. 22A, the step (S400) of drawing out the material module 400 from the bed 200 may include moving the rail 512 of the rail part 510 to the outside of the bed 200 along the guide 522 provided inside the main body 520 of the sliding jig 500 while the first coupling part 430 of the material module 400 and the second coupling part 514 of the rail part 510 are coupled as described above.

In this case, the method may include separating the first coupling part 430 of the material module 400 drawn out from the bed 200 while coupled to the rail part 510 from the second coupling part 514 and removing the material module 400 from the rail part 510.

FIG. 22B illustrates a state in which the material module 400 is removed from FIG. 22A. As illustrated, as the rail part 510 moves to the outside of the bed 200, a portion of the rail part 510 that comes out to the outside of the bed 200 may be partially drawn out from the main body 520.

Removing the material module 400 from the rail part 510 and recovering the sliding jig 500 to the outside of the bed may include moving the rail part 510 along the guide 522 and inserting the rail part 510 into the bed 200, lowering the main body 520 as the lifting bolt 532 rotates in the opposite direction, and drawing out the sliding jig 500, in which the rail part 510 and the main body 520 are coupled, from the bed 200 in parallel with the tray 300.

The sliding jig 500 drawn out from the bed 200 may be stored separately outside the bed 200.

In the above, only the drawing out and removing the material module 400 from the bed 200 of the heat storage reaction system 10 has been described, but the material module 400 in the heat storage reaction system 10 according to the present disclosure includes the process of removing the material module 400 that needs to be replaced and then disposing a new material module 400 in the bed 200, and may seat the new material module 400 on the tray 300 in the reverse order of the drawing out method.

For example, the step (S500) of seating the new material module 400 on the tray 300 may include removing the material module 400 from the rail part 510 coming out to the outside of the bed 200 and then coupling the second coupling part 514 of the rail part 510 to the first coupling part 430 disposed on both outer surfaces of the new material module 400, moving the rail part 510 along the guide 522 and inserting the rail part 510 into the bed 200, lowering the main body 520 as the lifting bolt 532 rotates in the opposite direction, separating the second coupling part 514 from the first coupling part 430, and seating the bottom of the new material module 400 on the tray 300, and drawing out the sliding jig 500 from the bed 200 in parallel with the tray 300.

As described above, according to the method of replacing a material module 400 in a heat storage reaction system 10 according to the present disclosure, it is possible to control the opening and closing between the chamber 100 and the plurality of beds 200, replace the material module 400 from the outside without the need for the worker having to enter the heat storage reaction system 10 since at least one surface of the bed 200 is a door type that can be fully opened and closed, replace the material module 400 inside the facility regardless of the operating state without the need for workers to enter the heat storage reaction system 10 or control the temperature for operation.

In addition, it is possible to independently replace the plurality of material modules 400 disposed to be spaced apart from each other in the bed 200 regardless of the order in which the material modules 400 are disposed.

Although preferred embodiments of the present disclosure have been described above, the present disclosure is not limited thereto, and the present disclosure can be variously modified within the scope of the claims, the detailed description of the present disclosure, and the appended drawings, and it is natural that various modifications also fall within the scope of the present disclosure.

What is claimed is:

1. A heat storage reaction system, comprising:
a chamber that includes a combustion chamber;
a plurality of beds that are disposed in a lower portion of the chamber, each bed of the plurality of beds including a plurality of trays, each tray of the plurality of trays having a material module disposed therein and fixed to form layers;
a plurality of connection passages, each connection passage connecting the lower portion of the chamber and an upper portion of a corresponding one of the plurality of beds; and
a plurality of valves, each valve configured to control opening and closing of a corresponding one of the connection passages,
wherein each of the beds includes one or more opening and closing parts on one side surface.

2. The heat storage reaction system of claim 1, wherein the tray comprises:
a first tray where a catalyst module accommodating a catalyst is disposed; and
a second tray where a heat storage module accommodating a heat storage material is disposed.

3. The heat storage reaction system of claim 1, wherein the plurality of trays are arranged in parallel with each other at regular intervals from each other, and both ends of each tray of the plurality of trays is fixed to an inner wall of the bed.

4. The heat storage reaction system of claim 1, wherein the material module includes a housing that accommodates a material therein and is seated on the tray, and a gasket disposed along a circumference of a lower surface of the housing.

5. The heat storage reaction system of claim 4, wherein the tray includes:
a circumference portion that has a shape following a circumference of the material module and includes an area in contact with the gasket; and
a central portion that has a hole provided inside the circumference portion.

6. The heat storage reaction system of claim 4, wherein the material module comprises first coupling parts provided on both outer surfaces of the housing.

7. The heat storage reaction system of claim 1, wherein a plurality of material modules are seated on one plane on each tray of the plurality of trays, and the plurality of material modules mounted on a same tray are arranged at regular intervals.

8. The heat storage reaction system of claim 7, wherein the tray comprises fixing parts on both sides of a seating part where the plurality of material modules are mounted.

9. The heat storage reaction system of claim 1,
wherein the material module comprises a third coupling part coupled to the tray at a front lower portion, and
wherein the tray comprises a fourth coupling part bolt-coupled to the material module through the third coupling part.

10. The heat storage reaction system of claim 1,
wherein the opening and closing part disposed on the one side surface of the bed includes a door that is coupled to the other side surface of an adjacent bed by a connector and is configured to be opened and closed, and
wherein when the opening and closing part is in a closed state of, an inner circumference of one side surface of the bed, which is in contact with an outer circumference of the door, is surrounded by a refractory.

11. A sliding jig that is disposed in a pair to face each other in parallel on both sides of a material module disposed on a tray in a bed of a heat storage reaction system, and draws out the material module from the heat storage reaction system, the sliding jig comprising:
a rail part that includes a rail extending along a longitudinal direction of the material module;
a main body that is provided with a guide on an inner side surface through which the rail moves; and
a lifting part that has an upper surface coupled to the main body and a bottom fixed to the tray.

12. The sliding jig of claim 11,
wherein the rail part has a second coupling part coupled to a first coupling part provided on both sides of the material module at a top of the rail, and
wherein the lifting part moves the main body to separate the material module from an upper surface of the tray while the second coupling part is coupled to the first coupling part.

13. The sliding jig of claim 12, wherein the lifting part comprises:
a lifting bolt that has one end penetrating through a clamp and configured to rotate about a longitudinal axis;
a clamp provided with a hole disposed along a longitudinal direction of the lifting bolt and through which the lifting bolt penetrates, and of which a bottom is fixed to fixing parts disposed on both sides of a seating part of the tray where the material module is seated; and
a cam plate of which one end is connected to the clamp and disposed along a longitudinal direction of the lifting part, and upper surface is in contact with the main body.

14. The sliding jig of claim 13, wherein the lifting bolt horizontally moves the cam plate according to rotation about the longitudinal axis, and at the same time, moves the cam plate and the main body upward.

15. A method of replacing material modules in a heat storage reaction system including a plurality of beds, the method comprising:
blocking, by a valve disposed at a connection passage between one bed of the plurality of beds and a chamber, the connection passage connecting the one bed and the chamber;
opening, by an opening and closing part disposed on a side surface of the one bed, one side surface of the one bed;
inserting a sliding jig into the one bed through the opened one side surface;
drawing out from the one bed, by the sliding jig, a material module to be replaced; and
inserting, by the sliding jig, a new material module into the one bed to seat the new material module on a seating part of a tray in the one bed.

16. The method of claim 15, wherein the inserting of the sliding jig into the one bed includes:
disposing a protrusion at a bottom of a clamp of the sliding jig to fit into a groove of a fixing part of the tray and then inserting the sliding jig into the one bed parallel to the tray.

17. The method of claim 16, wherein the drawing out of the material module includes:
coupling a second coupling part provided at a top of a rail part of the sliding jig to a first coupling part provided on both outer surfaces of the material module by horizontally moving and lifting a main body as a lifting bolt of the sliding jig rotates; and
moving a rail of the rail part to an outside of the one bed along a guide provided inside the main body of the sliding jig while the material module is coupled to the rail part.

18. The method of claim 17, further comprising:
removing the material module from the rail part by separating the first coupling part of the material module drawn out from the one bed in a state of being coupled to the rail part from the second coupling part.

19. The method of claim 18,
wherein after the removing the material module from the rail part, the method further includes recovering the sliding jig, and
wherein the recovering the sliding jig comprises:
inserting the rail part into the one bed by moving along the guide;
lowering the main body as the lifting bolt rotates in the opposite direction; and
drawing out the sliding jig to which the rail part and the main body are coupled, from the one bed.

20. The method of claim 18, wherein the seating of the new material module on the tray after removing the material module from the rail part includes:
coupling the second coupling part of the rail part to the first coupling parts disposed on both outer surfaces of the new material module;
inserting the new material module into the one bed by moving the rail part along the guide;
separating the second coupling part from the first coupling part and seating a bottom of the new material module on the tray, by lowering the main body as the lifting bolt rotates in an opposite direction; and
drawing out the sliding jig from the one bed.
